(19) United States
(12) Patent Application Publication
(10) Pub. No.: US 2022/0152774 A1
(43) Pub. Date: May 19, 2022

(54) SUBSTRATE PROCESSING APPARATUS AND SUBSTRATE PROCESSING METHOD

(71) Applicant: EBARA CORPORATION, Tokyo (JP)

(72) Inventor: TSUNEO TORIKOSHI, Tokyo (JP)

(73) Assignee: EBARA CORPORATION, Tokyo (JP)

(21) Appl. No.: 17/516,710

(22) Filed: Nov. 2, 2021

(30) Foreign Application Priority Data
Nov. 19, 2020 (JP) 2020-192585

(51) Int. Cl. B24B 37/005; B24B 37/20; G06T 7/00; B24B 49/12

(52) U.S. Cl. CPC B24B 37/005; B24B 37/20; G06T 2207/30108; B24B 49/12; G06T 2207/20081; G06T 7/001

(57) ABSTRACT

The disclosure improves the uniformity of polishing of a surface to be polished. A substrate processing apparatus includes: a support member having a support surface for supporting a polishing pad that is swung to the outside of a table; an imaging module for imaging a surface to be polished of the substrate supported by the table and the support surface of the support member; a storage part storing a learning model constructed by machine learning; a step estimation module learning the learning model by inputting imaging information obtained by the imaging module to the learning model, and estimating a step between the support surface and the surface to be polished by using the learning model; and an adjustment module for adjusting a height of the support surface while polishing the substrate based on the estimated step.

### CROSS-REFERENCE TO RELATED APPLICATION

This application claims the priority benefits of Japanese application no. 2020-192585, filed on Nov. 19, 2020. The entirety of the above-mentioned patent application is hereby incorporated by reference herein and made a part of this specification.

### BACKGROUND

### Technical Field

The disclosure relates to a substrate processing apparatus and a substrate processing method.

### Description of Related Art

A CMP (Chemical Mechanical Polishing) apparatus is known as an example of substrate processing apparatuses used in semiconductor processing. CMP apparatuses can be roughly divided into “face-up type (a system in which the surface to be polished of the substrate faces upward)” and “face-down type (a system in which the surface to be polished of the substrate faces downward)” depending on the direction in which the surface to be polished of the substrate is facing.

Patent Document 1 discloses that, in a face-up type CMP apparatus, a polishing pad having a smaller diameter than the substrate is brought into contact with the substrate while being rotated and swung to polish the substrate. It is disclosed that, in this CMP apparatus, a support member is provided around the substrate and the polishing pad swung to the outside of the substrate is supported by the support member, and the height and horizontal position of the support member can be adjusted.

Further, Patent Document 2 discloses that, in a transport system for transporting a substrate, a tilted part of a transport surface detection jig is detected by a transmission sensor from a side surface direction of the substrate to detect the tilt of the transport surface of the substrate. It is disclosed that, in the transport system described in Patent Document 2, an equation of the surface of the jig can be calculated by at least three orthogonal projection points.

### RELATED ART

### Patent Documents

[Patent Document 1] Japanese Laid-Open No. 2003-229388
[Patent Document 2] Japanese Laid-Open No. 2008-260599

### SUMMARY

### Problems to be Solved

The substrate to be polished by the CMP apparatus may have variations in thickness or surface profile due to manufacturing errors or the like. Therefore, in order to improve the uniformity of polishing of the surface to be polished, it is preferable to measure the thickness of the substrate to be processed in the substrate processing apparatus. However, if a sensor is provided on the side surface of the substrate as in the system described in Patent Document 2, the footprint of the substrate processing apparatus may become large.

In view of the above, the disclosure is to improve the uniformity of polishing of the surface to be polished.

### Means for Solving the Problems

An embodiment relates to a substrate processing apparatus, including: a table configured to support a substrate; a pad holder configured to hold a polishing pad that is configured to polish the substrate supported by the table; a drive module configured to swing the pad holder in a radial direction of the substrate; a support member having a support surface configured to support the polishing pad swung to outside of the table by the drive module; an imaging module configured to image a surface to be polished of the substrate supported by the table and the support surface; a storage part storing a learning model constructed by machine learning; a step estimation module learning the learning model by inputting imaging information obtained by the imaging module to the learning model, and estimating a step between the support surface and the surface to be polished by using the learning model; and an adjustment module configured to adjust a height of the support surface while polishing the substrate based on the step estimated.

### BRIEF DESCRIPTION OF THE DRAWINGS

FIG. 1 is a perspective view schematically showing the overall configuration of a substrate processing apparatus according to an embodiment.

FIG. 2 is a plan view schematically showing the overall configuration of a substrate processing apparatus according to an embodiment.

FIG. 3 is a perspective view schematically showing a table, a support member, and an imaging module according to an embodiment.

FIG. 4 is a side view schematically showing a table, a support member, and an imaging module according to an embodiment.

FIG. 5 is a functional block diagram of a step estimation module according to an embodiment.

FIG. 6 is a flowchart showing a substrate processing method according to an embodiment.

FIG. 7 is a view showing the schematic configuration of a substrate processing system in a modified example.

### DESCRIPTION OF THE EMBODIMENTS

Hereinafter, embodiments of a substrate processing apparatus and a substrate processing method according to the disclosure will be described with reference to the accompanying drawings. In the accompanying drawings, the same or similar elements are denoted by the same or similar reference numerals, and repeated descriptions of the same or similar elements may be omitted from the description of each embodiment. In addition, the features shown in an embodiment can be applied to other embodiments where no contradiction arises.

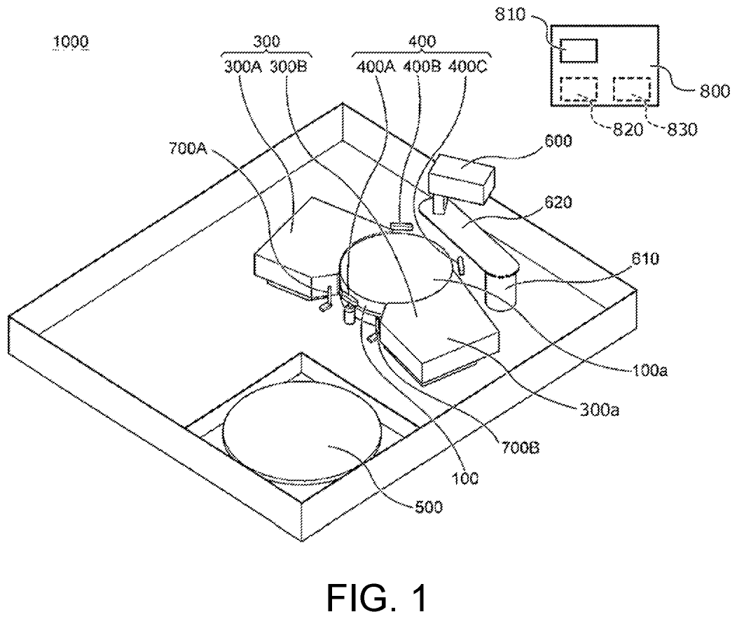

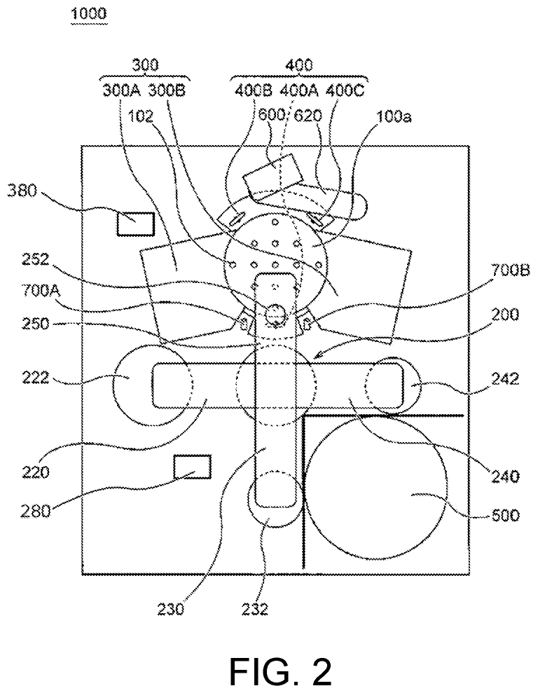

FIG. 1 is a perspective view schematically showing the overall configuration of the substrate processing apparatus according to an embodiment. FIG. 2 is a plan view schematically showing the overall configuration of the substrate processing apparatus according to an embodiment. The substrate processing apparatus 1000 shown in FIG. 1 and FIG. 2 includes a table 100, a multi-axis arm 200 (not shown in FIG. 1), support members 300A and 300B, centering mechanisms 400A to 400C, a dresser 500, an imaging module 600, cleaning nozzles 700A and 700B, and a control module 800.

### <Table>

The table 100 is a member for supporting a substrate WF to be processed. In an embodiment, the table 100 has a support surface 100a for supporting the substrate WF and is configured to be rotatable by a drive mechanism such as a motor (not shown). A plurality of holes 102 are formed on the support surface 100a (see FIG. 2), and the table 100 is configured so that the substrate WF can be vacuum-sucked via the holes 102.

### <Multi-Axis Arm>

The multi-axis arm 200 is a member that holds a plurality of processing tools for performing various processes on the substrate WF supported by the table 100, and is arranged adjacent to the table 100. The multi-axis arm 200 of the present embodiment is configured to hold a large-diameter polishing pad 222 for polishing the substrate WF, a cleaning tool 232 for cleaning the substrate WF, a small-diameter polishing pad 242 for finish polishing the substrate WF, and an atomizer 252 for discharging a liquid such as water to the substrate WF. In the present embodiment, the large-diameter polishing pad 222, the cleaning tool 232, the small-diameter polishing pad 242, and the atomizer 252 are respectively provided on a first arm 220, a second arm 230, a third arm 240, and a fourth arm 250 that extend radially. The multi-axis arm 200 further includes a drive module 280 for rotating, elevating, and swinging the polishing pads 222 and 242 with respect to the substrate WF supported by the table 100.

In the present embodiment, the first arm 220, the second arm 230, the third arm 240, and the fourth arm 250 extend radially around a swing shaft 210 at intervals of 90 degrees counterclockwise in a plan view. The drive module 280 can rotationally drive the first to fourth arms 220 to 250 to move any of the large-diameter polishing pad 222, the cleaning tool 232, the small-diameter polishing pad 242, and the atomizer 252 onto the substrate WF. Further, the drive module 280 can move the polishing pads 222 and 242 onto the dresser 500. In the present embodiment, the drive module 280 can rotationally drive the first to fourth arms 220 to 250 to swing (repeatedly move) the polishing pads 222 and 242 in an arc pattern on the substrate WF. However, the drive module 280 may be configured so that the polishing pads 222 and 242 can be swung on the substrate WF separately from the rotational drive of the first to fourth arms 220 to 250. The drive module 280 may swing the polishing pads 222 and 242 in a straight line.

For example, when the polishing pad 222 is on the substrate WF, the substrate processing apparatus 1000 rotates the table 100 and rotates the polishing pad 222, and swings the polishing pad 222 with a rotation drive mechanism 212 while pressing the polishing pad 222 against the substrate WF to polish the substrate WF.

### <Support Member>

As shown in FIG. 1 and FIG. 2, the substrate processing apparatus 1000 includes the first support member 300A arranged in a swing path of the polishing pad 222 outside the table 100, and the second support member 300B arranged in the swing path of the polishing pad 222 on a side opposite to the first support member 300A across the table 100. The first support member 300A and the second support member 300B are line-symmetrical with the substrate WF in between. Therefore, in the following description, the first support member 300A and the second support member 300B will be collectively referred to as the support member 300.

Further, in the following description, the function of the support member 300 when the large-diameter polishing pad 222 is swung with respect to the substrate WF will be described as an example, but the same applies to the cleaning tool 232 or the small-diameter polishing pad 242.

The support member 300 is a member for supporting the polishing pad 222 that is swung to the outside of the table 100 by the rotation of the swing shaft 210. That is, the substrate processing apparatus 1000 is configured to uniformly polish the surface to be polished of the substrate WF by swinging (overhanging) the polishing pad 222 until it protrudes to the outside of the substrate WF when polishing the substrate WF. Here, when the polishing pad 222 is overhung, the pressure of the polishing pad 222 is concentrated on the peripheral edge of the substrate WF due to various factors such as the tilt of a pad holder 226, and the surface to be polished of the substrate WF may not be uniformly polished. Therefore, in the substrate processing apparatus 1000 of the present embodiment, the support members 300 for supporting the polishing pad 222 overhanging to the outside of the substrate WF are provided on both sides of the table 100.

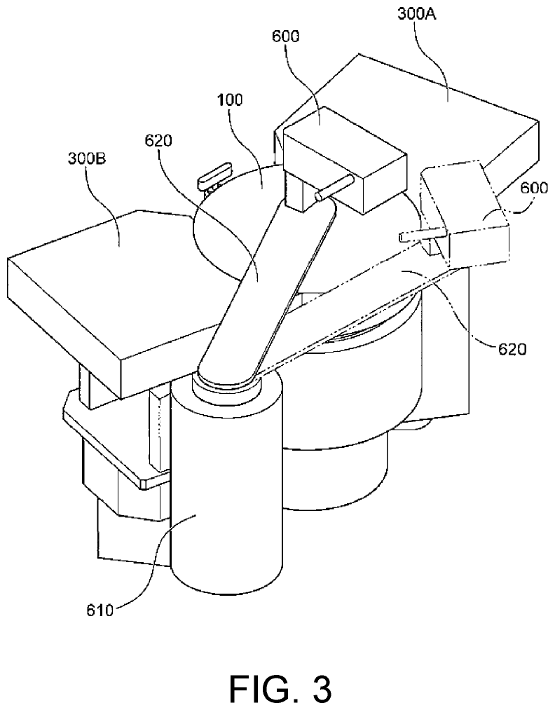

FIG. 3 is a side view schematically showing the table and the support member according to an embodiment. As shown in FIG. 3, the support member 300 (the first support member 300A and the second support member 300B, respectively) has a support surface 300a capable of supporting the entire polishing surface 222a of the polishing pad 222 in contact with the substrate WF. That is, since the support surface 300a has an area larger than the area of the polishing surface 222a of the polishing pad 222, even if the polishing pad 222 completely overhangs to the outside of the substrate WF, the entire polishing surface 222a is still supported by the support surface 300a. As a result, in the present embodiment, when the polishing pad 222 is swinging on the substrate WF, the entire polishing surface 222a is in contact with the substrate WF and is supported, and when the polishing pad 222 is swinging to the outside of the table 100, the entire polishing surface 222a is still supported by the support member 300.

Therefore, the polishing pad 222 does not protrude from the region of the surface to be polished of the substrate WF and the support surface 300a during swinging.

As shown in FIG. 2, the substrate processing apparatus 1000 includes a support member drive mechanism 380 for changing the height of the support member 300. The support member drive mechanism 380 can be configured with various known mechanisms such as a motor and a ball screw, and can adjust the support member 300 (support surface 301a and support surface 301b) to a desired height. The support member drive mechanism 380 may be configured so that the distance of the support member 300 with respect to the substrate WF can be adjusted by adjusting the horizontal position of the support member 300, that is, the position along the radial direction of the substrate WF supported by the table 100.

### <Imaging Module>

The substrate processing apparatus 1000 includes the imaging module 600 for imaging the surface to be polished of the substrate WF supported by the table 100 and the support surface 300a of the support member 300. In the imaging module 600 of the present embodiment, as shown in FIG. 3, a rotating shaft 610 extending in the height direction is arranged adjacent to the table 100. The rotating shaft 610 can rotate around the axis of the rotating shaft 610 by a rotation drive mechanism such as a motor (not shown). A swing arm 620 is attached to the rotating shaft 610, and the imaging module 600 is attached to the tip of the swing arm 620. The imaging module 600 is configured to swing around the axis of the rotating shaft 610 by the rotation of the rotating shaft 610. As a result, the imaging module 600 can swing along the radial direction of the substrate WF by the rotation of the rotating shaft 610 during the polishing of the substrate WF. Nevertheless, the imaging module 600 is not limited to such an example, and may be fixed to a skeleton (not shown) in the substrate processing apparatus 1000 so as to face the table 100 and the support surface 300a.

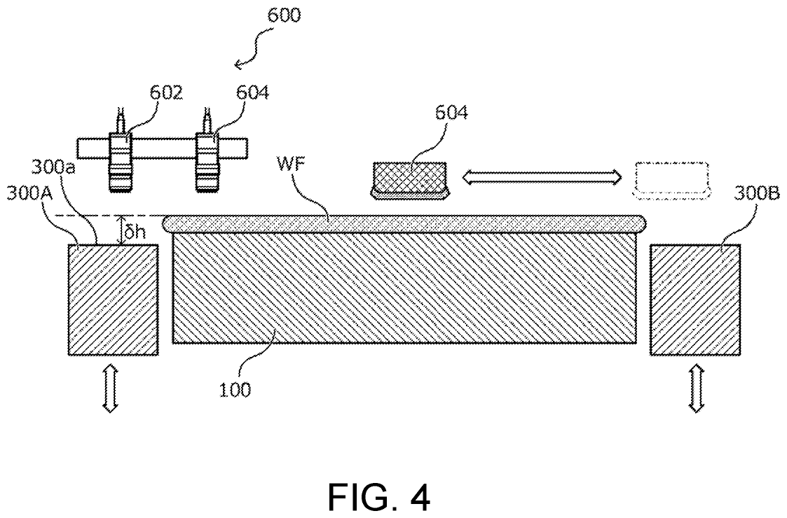

FIG. 4 is a side view schematically showing the table, the support member, and the imaging module according to an embodiment. The imaging module 600 can be arranged above the support surface 300a of the support member 300 and the table 100 so as to face the support surface 300a of the support member 300 and the table 100. In the present embodiment, the imaging module 600 includes a first imaging device 602 for imaging the support surface 300a of the support member 300, and a second imaging device 604 for imaging the table 100 or the surface to be polished of the substrate WF. The imaging devices 602 and 604 may be, for example, a CCD camera having a CCD sensor or a CMOS camera having a CMOS sensor. The first imaging device 602 and the second imaging device 604 are configured to be fixed to each other and move integrally. However, the disclosure is not limited to such an example, and the first imaging device 602 and the second imaging device 604 may be configured to be movable independently of each other. Further, the imaging module 600 does not necessarily have two imaging devices 602 and 604, and may be configured with one imaging device that is capable of imaging both the support surface 300a of the support member 300 and the table 100 or may be configured with three or more imaging devices.

### <Centering Mechanism>

As shown in FIG. 1 and FIG. 2, the substrate processing apparatus 1000 includes the centering mechanisms 400A to 400C for centering the substrate WF. In the present embodiment, the centering mechanisms 400A to 400C are configured to press and align the substrate WF supported by the table 100 in the center direction of the table 100. The centering mechanisms 400A, 400B, and 400C are arranged around the table 100 at appropriate intervals.

The control module 800 may calculate the diameter of the substrate WF based on the alignment result of the substrate WF obtained by the centering mechanisms 400A, 400B, and 400C.

### <Dresser>

As shown in FIG. 1 and FIG. 2, the dresser 500 is arranged in the path of turning of the polishing pads 222 and 242 due to the rotation of the swing shaft 210. The dresser 500 is a member for sharpening (dressing) the polishing pads 222 and 242 by strongly electrodepositing diamond particles or the like on the surfaces. The dresser 500 is configured to rotate by a rotation drive mechanism such as a motor (not shown). Pure water can be supplied to the surface of the dresser 500 from a nozzle (not shown). The substrate processing apparatus 1000 rotates the dresser 500 while supplying pure water from the nozzle to the dresser 500, and rotates the polishing pads 222 and 242 and swings them with respect to the dresser 500 while pressing them against the dresser 500. As a result, the polishing pads 222 and 242 are scraped off by the dresser 500, and the polishing surfaces of the polishing pads 222 and 242 are dressed.

### <Cleaning Nozzle>

As shown in FIG. 1 and FIG. 2, the cleaning nozzles 700A and 700B are arranged adjacent to the table 100. The cleaning nozzle 700A is configured to supply a cleaning liquid such as pure water toward a gap between the table 100 and the support member 300A. As a result, polishing debris or the like that has entered between the table 100 and the support member 300A can be washed away. The cleaning nozzle 700B is configured to supply a cleaning liquid such as pure water toward a gap between the table 100 and the support member 300B. As a result, polishing debris or the like that has entered between the table 100 and the support member 300B can be washed away.

### <Control Module>

As shown in FIG. 1, the substrate processing apparatus 1000 includes the control module 800 that controls the entire apparatus. Information from various sensors including the imaging module 600 is input to the control module 800. Further, the control module 800 can send commands to various devices such as the table 100, the multi-axis arm 200, and the support member drive mechanism 380. The control module 800 includes a storage part 810 and a calculation part such as a CPU (not shown). The control module 800 may be configured by a microcomputer that realizes a predetermined function by using software, or may be configured by a device that performs dedicated arithmetic processing. In the present embodiment, the control module 800 functions as a step estimation module 820 and an adjustment module 830, which will be described later.

### <Step Estimation Module>

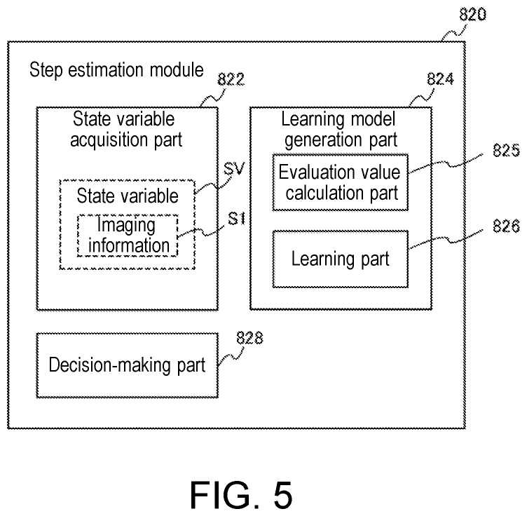

The step estimation module 820 is configured to estimate a step (height difference, see FIG. 4) δh between the support surface 300a of the support member 300 and the surface to be polished of the substrate WF based on imaging information obtained by the imaging module 600 and a learning model stored in the storage part 810. In the present embodiment, the control module 800 functions as the step estimation module 820. FIG. 5 is a schematic functional block diagram of the step estimation module 820 according to the present embodiment. The step estimation module 820 includes a state variable acquisition part 822 that acquires a state variable SV, a learning model generation part 824 that learns/generates the learning model stored in the storage part 810 based on the acquired state variable SV, and a decision-making part 828 that estimates (decides) the step a between the support surface 300a of the support member 300 and the surface to be polished of the substrate WF based on the acquired state variable SV and the learning model.

The state variable acquisition part 822 acquires the state variable SV every predetermined time (for example, several msec and several tens of msec). As an example, the predetermined time can be the same as or corresponding to a learning cycle of the learning model generation part 824. In the present embodiment, the input of information from various sensors to the control module 800 corresponds to the acquisition of the state variable SV by the state variable acquisition part 822. The state variable SV includes at least the imaging information 51 obtained by the imaging module 600. Here, the imaging information 51 includes the imaging information of the support surface 300a obtained by the first imaging device 602 and the imaging information of the surface to be polished of the substrate WF obtained by the second imaging device 604. The imaging information 51 may include a focus value and an F value of the imaging module 600 (imaging devices 602 and 604), and may include the position of each of a plurality of imaging elements in the imaging devices 602 and 604 and the focus value of the imaging element. Further, the state variable SV may include the height adjustment amount of the support member 300 made by the control module 800 or the output value (rotation torque command value or motor current) of the drive module 280 in the table 100 or the polishing pads 222 and 242 (multi-axis arm 200) in addition to the imaging information obtained by the imaging module 600. Besides, the state variable SV may include the thickness information or surface profile information of the substrate WF measured or estimated by another sensor or the like (not shown). Such a state variable SV may be acquired while the substrate WF is being polished, or may be acquired before or after the substrate WF is polished. Further, the state variable SV may include the information previously input to the substrate processing apparatus 1000 by a user. As an example, the state variable SV may include information on the material of the substrate WF.

The learning model generation part 824 learns the learning model (estimated value of the step a with respect to the state variable SV) according to an arbitrary learning algorithm collectively called machine learning. The learning model generation part 824 repeatedly executes learning based on the state variable SV acquired by the state variable acquisition part 822. The learning model generation part 824 acquires a plurality of state variables SV, identifies the features of the state variables SV, and interprets the correlation. Further, the learning model generation part 824 interprets the correlation of the state variable SV to be acquired next time when the step a between the support member 300 and the substrate WF is estimated with respect to the current state variable SV. Then, the learning model generation part 824 optimizes the estimation of the step δh between the support member 300 and the substrate WF with respect to the acquired state variable SV by repeating the learning.

As an example, the learning model generation part 824 is constructed by supervised learning. Supervised learning may be performed at an installation site of the substrate processing apparatus 1000, at a manufacturing site, or at a dedicated learning site. As an example of supervised learning, the learning model generation part 824 may use the imaging information of the table 100 in a state where the substrate WF is not placed as teacher data.

Further, as an example of supervised learning, the learning model generation part 824 may use the imaging information of a reference substrate prepared in advance as teacher data. A substrate having a known thickness or plate surface profile can be used as the reference substrate. The reference substrate may have a uniform thickness, or may have a predetermined uneven pattern formed as the surface profile. Furthermore, as an example of supervised learning, the learning model generation part 824 may use the imaging information of the support surface 300a of the support member 300 as teacher data. In this case, a plurality of pieces of imaging information may be acquired for each height of the support surface 300a of the support member 300, and the height information of the support surface 300a for each piece of imaging information may be used as teacher data. As an example, in a state where the substrate WF is not placed or in a state where the reference substrate is placed, the support surface 300a and the table 100 (or the reference substrate) are imaged by the imaging module 600 while the height of the support surface 300a of the support member 300 is changed, and the imaging information can be used as teacher data.

Moreover, the learning model generation part 824 may execute reinforcement learning to learn the learning model. Reinforcement learning is a method of generating a learning model that rewards the action (output) executed for the current state (input) in a certain environment and obtains the maximum reward. As an example of performing reinforcement learning, the learning model generation part 824 has an evaluation value calculation part 825 that calculates an evaluation value based on the state variable SV, and a learning part 826 that learns the learning model based on the evaluation value. As an example, the evaluation value calculation part 825 may give a larger reward as the stability of the state variable SV becomes higher, that is, give a larger reward as the change between the state variable SV acquired last time and the state variable SV acquired this time becomes smaller. Further, as an example, the evaluation value calculation part 825 may give a larger reward as the step δh between the substrate WF being polished and the support member 300 becomes smaller and the estimated step δh approaches the value 0. Further, as an example, the evaluation value calculation part 825 may give a larger reward as the stability of the load in the drive module 280 becomes higher. In addition, as an example, the evaluation value calculation part 825 may give a larger reward as the energy consumption in the substrate processing apparatus 1000 becomes smaller. Further, as an example, the evaluation value calculation part 825 may give a larger reward as the time required for the polishing process in the substrate processing apparatus 1000 becomes shorter. Further, as an example, the evaluation value calculation part 825 may give a larger reward as the surface profile of the substrate WF becomes constant.

### <Adjustment Module>

The adjustment module 830 is configured to adjust the height of the support surface 300a during polishing based on the step a between the substrate WF and the support surface 300a estimated by the step estimation module 820. In the present embodiment, the support member drive mechanism 380 for driving the support member 300 and the control module 800 for sending a command to the support member drive mechanism 380 function as the adjustment module. Based on the estimated value of the step δh between the substrate WF and the support surface 300a, the adjustment module 830 (control module 800) drives the support member drive mechanism 380 so that the step between the substrate WF and the support surface 300a becomes the value 0.

### <Flowchart>

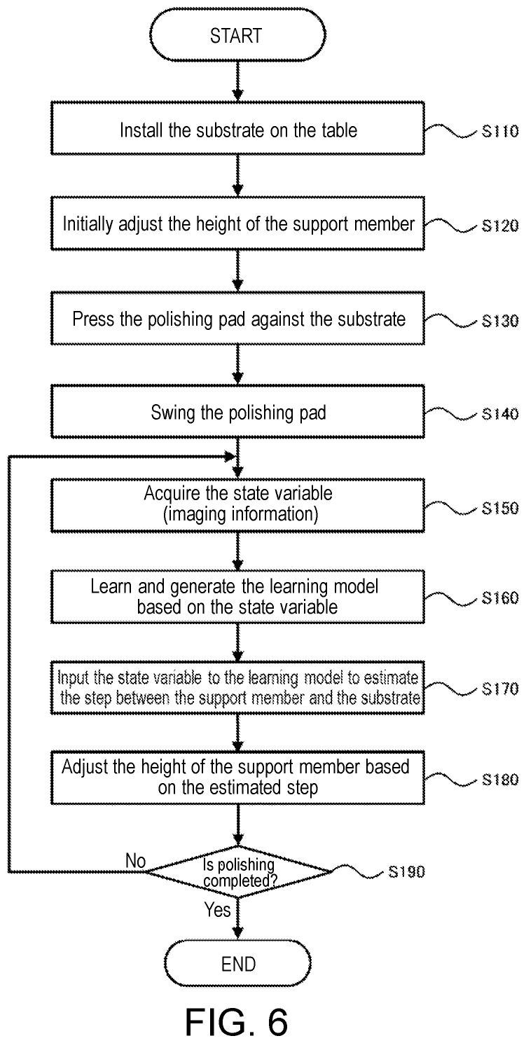

Next, the procedure of the substrate processing method including the adjustment of the height position of the support member 300 according to the present embodiment will be described. FIG. 6 is a flowchart showing the substrate processing method according to an embodiment. As shown in FIG. 6, in the substrate processing method, first, the substrate WF is installed on the table 100 (S110: installation step). The installation step may be performed by a transport mechanism (not shown) or by the user. Subsequently, the substrate WF is aligned by the centering mechanisms 400A, 400B, and 400C (S120). The height of the support member 300 may be initially adjusted. The initial adjustment of the height of the support member 300 may be performed based on, for example, the thickness of the substrate WF measured in advance, or may be performed based on the step a estimated by the step estimation module 820 after the substrate WF is placed.

Subsequently, the table 100 is rotated and the polishing pad 222 is pressed against the substrate WF while being rotated (S130: pressing step). Subsequently, the polishing pad 222 is swung (S140: swinging step). Subsequently, the support surface 300a of the support member 300 and the surface to be polished of the substrate WF are imaged (imaging step), and the state variable including the imaging information is acquired (S150). Subsequently, the learning model is learned and generated based on the acquired state variable (S160). Subsequently, the state variable is input to the learning model to estimate the step δh between the support surface 300a and the surface to be polished of the substrate WF (S170: step estimation step). Subsequently, the height of the support surface 300a is adjusted while the substrate WF is being polished based on the estimated step a (S180: adjustment step).

Then, the processes of S150 to S180 are repeatedly executed until the polishing is completed (S190, No), and when the polishing is completed (S190, Yes), the substrate processing method is completed.

According to the substrate processing apparatus 1000 of the present embodiment described above, the surface to be polished of the substrate WF supported by the table 100 and the support surface 300a of the support member 300 are imaged by the imaging module 600, and the step a between the support surface 300a and the surface to be polished of the substrate WF is estimated based on the imaging information. Then, the substrate processing apparatus 1000 adjusts the height of the support surface 300a during polishing based on the estimated step a. According to such a substrate processing apparatus 1000, the height of the support surface 300a can be suitably adjusted during polishing, and the uniformity of polishing of the surface to be polished can be improved. Moreover, since the imaging module 600 is provided to face the support member 300 and the table 100, the substrate processing apparatus 1000 of the present embodiment can realize the above functions and effects without increasing the footprint.

### <Modified Example 1>

In the above-described embodiment, the control module 800 (step estimation module 820) estimates the step δh between the support surface 300a of the support member 300 and the surface to be polished of the substrate WF. In addition to this, the control module 800 may be capable of measuring the thickness of the substrate WF based on the imaging information obtained by the imaging module 600 and the learning model. As an example, the control module 800 may measure the thickness of the substrate WF based on the step δh between the support surface 300a and the substrate WF and the height position of the support surface 300a.

### <Modified Example 2>

Further, the control module 800 may be capable of measuring the surface profile of the substrate WF based on the imaging information obtained by the imaging module 600 and the learning model. As an example, the control module 800 may image the surface to be polished of the substrate WF with the imaging module 600 while rotating the substrate WF, and estimate the thickness of the substrate WF for each circumferential position (or the step δh between the support surface 300a and the surface to be polished) based on the imaging information and the learning model, thereby measuring the surface profile of the substrate WF.

### <Modified Example 3>

Further, in the above-described embodiment, the imaging module 600 is used to estimate the step δh between the support surface 300a of the support member 300 and the surface to be polished of the substrate WF. In addition to this, the imaging module 600 may be used to detect a notch (not shown) formed in advance on the substrate WF. In this way, the imaging module 600 serves as both a mechanism for detecting the notch and a mechanism for estimating the step δh between the support surface 300a and the surface to be polished of the substrate WF, and therefore the number of parts in the substrate processing apparatus 1000 can be reduced.

### <Modified Example 4>

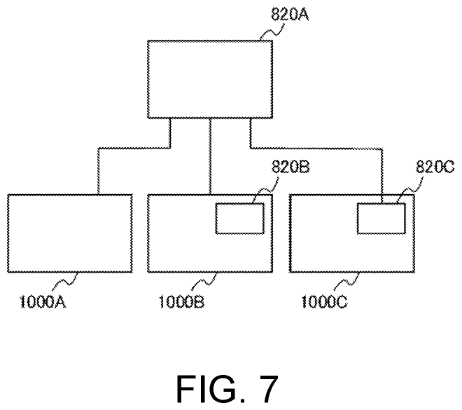

FIG. 7 is a view showing the schematic configuration of a substrate processing system in a modified example. The substrate processing system includes a step estimation system 820A and a plurality of substrate processing apparatuses (three AM apparatuses 1000A, 1000B, and 1000C in the example shown in FIG. 7) that are connected to communicate in a wired or wireless manner. The step estimation system 820A in the modified example is configured to be capable of realizing generally the same function as the step estimation module 820 in the above-described embodiment, and repeated descriptions will be omitted. The step estimation system 820A of the modified example can acquire the state variables SV from a plurality of substrate processing apparatuses. As a result, the step estimation system 820A can acquire more state variables SV and improve the learning accuracy of the learning model. As an example, the plurality of substrate processing apparatuses may include the substrate processing apparatus 1000A that does not include the step estimation module 820A. When a machine learning device is not included, the substrate processing apparatus 1000A may estimate the step δh by using the learning model updated and transmitted from the step estimation system 820A to perform substrate processing. Further, as an example, the plurality of substrate processing apparatuses may include the substrate processing apparatuses 1000B and 1000C each including the step estimation module 820. The substrate processing apparatuses 1000B and 1000C include step estimation modules 820B and 820C having the same function and configuration as the step estimation module 820 in the above-described embodiment. In this case, the step estimation system 820A and the step estimation modules 820B and 820C may mutually acquire the learning model generated by each of them to optimize the learning model. Further, any one of the step estimation system 820A and the step estimation modules 820B and 820C may be configured to function as a host, acquire a plurality of learning models, optimize the learning model, and transmit an updated learning model to the subordinate step estimation system or step estimation module. Here, the generation of a distillation model based on a plurality of learning models is an example of the optimization of the learning model performed by the step estimation system or the step estimation module.

Although the embodiments of the disclosure have been described above based on some examples, the above-described embodiments of the disclosure are for facilitating the understanding of the disclosure and do not limit the disclosure. The disclosure can be modified and improved without departing from the spirit thereof, and it goes without saying that the disclosure includes an equivalent thereof. In addition, within the range where at least a part of the above-mentioned problem can be solved or at least a part of the effect can be achieved, any combination or omission of each component described in the claims and specification is possible.

At least the following technical ideas are grasped from the above-described embodiment.
[Form 1] According to form 1, a substrate processing apparatus is proposed, including: a table configured to support a substrate; a pad holder configured to hold a polishing pad that is configured to polish the substrate supported by the table; a drive module configured to swing the pad holder in a radial direction of the substrate; a support member having a support surface configured to support the polishing pad swung to outside of the table by the drive module; an imaging module configured to image a surface to be polished of the substrate supported by the table and the support surface; a storage part storing a learning model constructed by machine learning; a step estimation module learning the learning model by inputting imaging information obtained by the imaging module to the learning model, and estimating a step between the support surface and the surface to be polished by using the learning model; and an adjustment module configured to adjust a height of the support surface while polishing the substrate based on the step estimated. According to form 1, the height of the support surface can be suitably adjusted during polishing, and the uniformity of polishing of the surface to be polished can be improved.
[Form 2] According to form 2, based on form 1, the step estimation module learns the learning model by inputting imaging information of the table obtained by the imaging module in a state where the substrate is not placed to the learning model.
[Form 3] According to form 3, based on form 1 or 2, the step estimation module is capable of measuring a thickness of the substrate based on the imaging information obtained by the imaging module and the learning model.
[Form 4] According to form 4, based on forms 1 to 3, the step estimation module is capable of measuring a surface profile of the substrate based on the imaging information obtained by the imaging module and the learning model.
[Form 5] According to form 5, based on forms 1 to 4, the imaging module functions as a notch detection module detecting a notch formed in advance on the substrate.
[Form 6] According to form 6, based on forms 1 to 5, the learning model is constructed by learning with imaging information of the support surface obtained by the imaging module as teacher data.
[Form 7] According to form 7, based on forms 1 to 6, the learning model is constructed by learning with imaging information of a reference substrate obtained by the imaging module as teacher data.
[Form 8] According to form 8, based on forms 1 to 7, the imaging module is provided so as to face the support surface and the table.
[Form 9] According to form 9, based on forms 1 to 8, the imaging module includes a CCD sensor or a CMOS sensor.
[Form 10] According to form 10, based on forms 1 to 9, the step estimation module estimates the step based on at least a focus value in the imaging information obtained by the imaging module.
[Form 11] According to form 11, based on forms 1 to 10, the support member includes a first support member arranged in a swing path of the polishing pad outside the table, and a second support member arranged in the swing path of the polishing pad on a side opposite to the first support member across the table.
[Form 12] According to form 12, a substrate processing method is proposed, including: an installation step of installing a substrate on a table; a pressing step of pressing a polishing pad configured to polish the substrate installed on the table against the substrate; a swinging step of swinging the polishing pad in a radial direction of the substrate; an imaging step of imaging a support surface configured to support the polishing pad swung to outside of the table by the swinging step and a surface to be polished of the substrate supported by the table; a step estimation step of learning a learning model by inputting imaging information obtained by the imaging step to the learning model, and estimating a step between the support surface and the surface to be polished by using the learning model; and an adjustment step of adjusting a height of the support surface while polishing the substrate based on the step estimated by the step estimation step.
[Form 13] According to form 13, based on form 12, the substrate processing method further includes a learning step of learning the learning model by inputting imaging information of the table in a state where the substrate is not placed to the learning model.
[Form 14] According to form 14, based on form 12 or 13, the learning model is constructed by learning with imaging information of the support surface obtained by the imaging module as teacher data.
[Form 15] According to form 15, based on forms 12 to 14, the learning model is constructed by learning with imaging information of a reference substrate obtained by the imaging module as teacher data.

What is claimed is:

1. A substrate processing apparatus, comprising:
a table configured to support a substrate;
a pad holder configured to hold a polishing pad that is configured to polish the substrate supported by the table;
a drive module configured to swing the pad holder in a radial direction of the substrate;
a support member having a support surface configured to support the polishing pad swung to outside of the table by the drive module;
an imaging module configured to image a surface to be polished of the substrate supported by the table and the support surface;
a storage part storing a learning model constructed by machine learning;
a step estimation module learning the learning model by inputting imaging information obtained by the imaging module to the learning model, and estimating a step between the support surface and the surface to be polished by using the learning model; and
an adjustment module configured to adjust a height of the support surface while polishing the substrate based on the step estimated.

2. The substrate processing apparatus according to claim 1, wherein the step estimation module learns the learning model by inputting imaging information of the table obtained by the imaging module in a state where the substrate is not placed to the learning model.

3. The substrate processing apparatus according to claim 1, wherein the step estimation module is capable of measuring a thickness of the substrate based on the imaging information obtained by the imaging module and the learning model.

4. The substrate processing apparatus according to claim 1, wherein the step estimation module is capable of measuring a surface profile of the substrate based on the imaging information obtained by the imaging module and the learning model.

5. The substrate processing apparatus according to claim 1, wherein the imaging module functions as a notch detection module detecting a notch formed in advance on the substrate.

6. The substrate processing apparatus according to claim 1, wherein the learning model is constructed by learning with imaging information of the support surface obtained by the imaging module as teacher data.

7. The substrate processing apparatus according to claim 1, wherein the learning model is constructed by learning with imaging information of a reference substrate obtained by the imaging module as teacher data.

8. The substrate processing apparatus according to claim 1, wherein the imaging module is provided so as to face the support surface and the table.

9. The substrate processing apparatus according to claim 1, wherein the imaging module comprises a CCD sensor or a CMOS sensor.

10. The substrate processing apparatus according to claim 1, wherein the step estimation module estimates the step based on at least a focus value in the imaging information obtained by the imaging module.

11. The substrate processing apparatus according to claim 1, wherein the support member comprises a first support member arranged in a swing path of the polishing pad outside the table, and a second support member arranged in the swing path of the polishing pad on a side opposite to the first support member across the table.

12. A substrate processing method, comprising:
an installation step of installing a substrate on a table;
a pressing step of pressing a polishing pad configured to polish the substrate installed on the table against the substrate;
a swinging step of swinging the polishing pad in a radial direction of the substrate;
an imaging step of imaging a support surface configured to support the polishing pad swung to outside of the table by the swinging step and a surface to be polished of the substrate supported by the table;
a step estimation step of learning a learning model by inputting imaging information obtained by the imaging step to the learning model, and estimating a step between the support surface and the surface to be polished by using the learning model; and
an adjustment step of adjusting a height of the support surface while polishing the substrate based on the step estimated by the step estimation step.

13. The substrate processing method according to claim 12, further comprising a learning step of learning the learning model by inputting imaging information of the table in a state where the substrate is not placed to the learning model.

14. The substrate processing method according to claim 12, wherein the learning model is constructed by learning with imaging information of the support surface obtained by the imaging step as teacher data.

15. The substrate processing method according to claim 12, wherein the learning model is constructed by learning with imaging information of a reference substrate obtained by the imaging step as teacher data.
